(19) United States
(12) Patent Application Publication
(10) Pub. No.: US 2026/0217470 A1
(43) Pub. Date: Jul. 30, 2026

(54) SNAP LOCK CONVEYOR COMPONENT

(71) Applicant: Laitram, L.L.C., Harahan, LA (US)

(72) Inventors: Ryan Hale, New Orleans, LA (US); Jonathan J. Bishop, Amite, LA (US)

(21) Appl. No.: 19/145,371

(22) PCT Filed: Jan. 10, 2024
(86) PCT No.: PCT/US2024/011013

§ 371 Date: Jul. 2, 2025

Related U.S. Application Data
(60) Provisional application No. 63/440,523, filed on Jan. 23, 2023.

(51) Int. Cl. B65G 23/04; B65G 39/04

(52) U.S. Cl. CPC B65G 23/04; B65G 39/04

(57) ABSTRACT

A conveyor component for use in a conveyor includes a flexible bore hole for mounting the conveyor component on a shaft. The flexible bore hole includes clearance regions for allowing the component to slide over an associated shaft in a first orientation and retaining features for locking the component onto a mounting region of the shaft in a second orientation.

### RELATED APPLICATIONS

The present application claims priority to U.S. Provisional patent application Ser. No. 63/440,523 filed Jan. 23, 2023 and entitled “Snap Lock Conveyor Component”, the contents of which are herein incorporated by reference.

### FIELD OF THE INVENTION

The present application relates to power-driven conveyors. More particular, the present invention relates to rollers and other components used to support a conveyor belt in a returnway, infeed or another location where a conveyor belt requires support.

### BACKGROUND OF THE INVENTION

Conveyor belts are used in many industries to convey products from first location to a second location. Conveyor belts generally form an endless belt loop that is trained around drive and idler sprockets or rollers at each end of a conveying path. Articles conveyed atop the conveyor belt are supported along an upper carryway. The conveyor belt returns along a lower returnway. To minimize the maximum sag of the conveyor belt in the returnway, return shoes or rollers are often used. Return rollers typically extend across the width of the conveyor belt at selected positions along the returnway and are mounted on a shaft. Rollers may also be used to support a conveyor belt at the infeed end of the endless conveyor belt circuit and—or another location. Other shaft-mounted components are also used in conveyors to support, contain and—or guide a conveyor belt.

Mounting such conveyor components on a shaft often involves using separate retaining mechanisms that may increase the complexity of the system and pose potential for hygiene and—or breakage issues.

### SUMMARY OF THE INVENTION

A conveyor component for mounting on a shaft having shaped corners in a mounting region includes a flexible bore hole. The flexible bore hole has clearance regions corresponding to corners of the shaft for allowing the component to slide over the associated shaft in a first orientation and retaining features for locking the component onto the mounting region of the shaft in a second orientation.

According to one aspect, a combination of a shaft and a roller mounted on the shaft for a conveyor system comprises a shaft extending along a longitudinal axis and having n flat surfaces intersecting at n corners and a plurality of mounting regions, each mounting region comprising an angled surface in each corner of the shaft. The roller comprises a body having a flexible bore hole, the bore hole defined by n shaped sections. Each shaped section comprises a first portion forming a clearance region for a corresponding corner, the first portion transitioning to a first flexible tab for containing the shaft by contacting a first edge of an angled surface, the first flexible tab transitioning to a retaining recess, the retaining recess transitioning to a second flexible tab for contacting a second edge of the angled surface.

According to another aspect, a conveyor component, comprises a body and a flexible bore hole for mounting the body to a shaft. The flexible bore hole is defined by n shaped sections, each shaped section comprising a first clearance portion, the first clearance portion transitioning to a first flexible tab, the first flexible tab transitioning to a retaining recess, the retaining recess transitioning to a second flexible tab and a second clearance portion identical to the first clearance portion extending from the second flexible tab and terminating at the beginning of a successive shaped section.

According to another aspect, a method of mounting a roller on a shaft in a conveyor system, comprises the steps of aligning corners on the shaft with clearance regions in a bore hole on the roller, sliding the roller along the shaft until a mounting region of the shaft is within the bore hole and rotating the roller about the shaft so that angled surfaces in the mounting region on the shaft snap into retaining features in the bore hole.

### BRIEF DESCRIPTION OF THE DRAWINGS

FIG. 1 is an isometric view of a roller assembly for a conveyor according to an embodiment;

FIG. 2 is an isometric view of the shaft of the roller assembly of FIG. 1;

FIG. 3 is a front view of the shaft of FIG. 2;

FIG. 4 is a front view of a roller of the roller assembly of FIG. 1;

FIG. 5 is a detailed view of a bore hole of the roller of FIG. 3;

FIG. 6 is a detailed view of a shaped section of the bore hole of FIG. 5;

FIG. 7 is another view of the shaped section of FIG. 6;

FIGS. 8A-8C show a sequence of steps of mounting a roller on a shaft according to an embodiment;

FIGS. 9A-9C are cross-sectional views of the roller and shaft of FIGS. 8A-8C during the steps of mounting the roller on the shaft;

FIG. 10 is a side view of a roller and shaft of a roller assembly including sloped containment surfaces in the mounting region of the shaft, according to another embodiment;

FIGS. 11A-11C show a portion of a roller assembly and a tool for locking a roller onto a shaft of the roller assembly according to another embodiment;

FIG. 12 shows a portion of a roller assembly including openings in the body of a roller and a tool for locking the roller onto a shaft according to another embodiment;

FIG. 13 portion of a roller assembly and a tool for locking a roller onto a shaft of the roller assembly according to another embodiment;

FIG. 14 is a front view of a roller showing geometries used to determine a suitable bore hole according to an embodiment of the invention;

FIG. 15 shows the geometries of FIG. 14;

FIG. 16 is a detailed view of a portion of the geometries of FIG. 14;

FIG. 17 shows a flexible bore hole shape according to another embodiment;

FIG. 18 shows a flexible bore hole shape according to another embodiment;

FIG. 19 shows a flexible bore hole shape according to another embodiment;

FIG. 20 shows a flexible bore hole shape according to another embodiment;

FIG. 21 shows a flexible bore hole shape according to another embodiment;

FIG. 22 shows a flexible bore hole shape according to another embodiment;

FIG. 23 shows a flexible bore hole with relief spaces according to another embodiment.

### DETAILED DESCRIPTION

A conveyor component, such as a roller, includes a flexible hub for mounting the roller on a shaft and locking the component onto the shaft. The invention will be described below relative to certain illustrative embodiments, though those skilled in the art will recognize that the invention is not limited to the described embodiments.

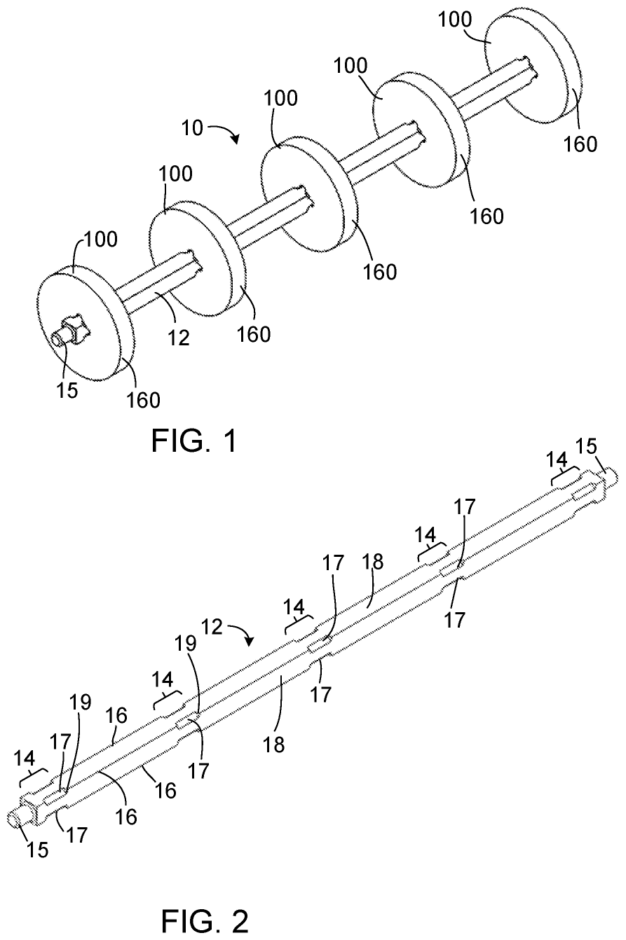

Referring to FIGS. 1-2, a conveyor assembly, shown as a conveyor roller assembly 10, comprises a series of conveyor rollers 100 mounted on a mounting shaft 12 in a conveyor. The illustrative series of conveyor rollers 100 are evenly spaced at mounting regions 14 along the axial length of the mounting shaft, but the invention is not so limited, and any number conveyor rollers 100 can be mounted in any suitable location and—or patterns. In one embodiment, the conveyor rollers are returnway rollers, mounted in the returnway of a conveyor for guiding and—or supporting the conveyor belt as it travels from the outfeed, discharge end, back to the infeed of the conveyor. As the conveyor belt moves over the outer rims 160 of the conveyor rollers 100, it may spin the conveyor roller assembly 100. The illustrative rollers 100 are fixedly mounted to the mounting shaft 12 during operation, with end journals 15 inserted in bearings to allow spinning of the whole assembly 100 in unison. One skilled in the art will recognize that the illustrative conveyor roller assembly may be implemented in any suitable location in a conveyor, such as the infeed or other suitable location where support of a conveyor belt is useful. Other suitable types of conveyor components can also be mounted on a shaft in a similar fashion.

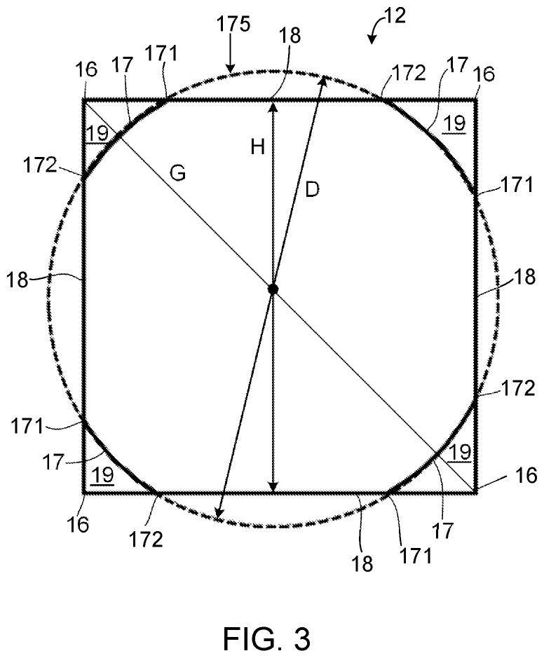

As shown in FIGS. 2 and 3, the illustrative mounting shaft 12 has a substantially square cross-section defined by four corners 16 and four flat side walls 18. In each mounting region 14, the corners 16 are cut or otherwise shaped to form angled surfaces 17 that reduce the overall size of the shaft 12 in that region. The illustrative angled surfaces 17 are convexly curved and extend from a first edge 171 to a second edge 172. The illustrative angled surfaces 17 form arcs of a circle 175 having a diameter D that is greater than the height H (and therefore width) of the square shaft 12 but less than the diagonal G of the square shaft 12. The circle 175 is centered around the shaft 12. As shown, imaginary arcs of the circle 175 that do not comprise the angled surfaces 17 extend outside the flat side walls 18 of the shaft 12.

The angled surfaces 17 create substantially triangular containing walls 19 for helping to contain the rollers 100 axially. The illustrative containing walls 19 extend perpendicular to the longitudinal axis of the shaft, but alternatively, the containing walls may be sloped or otherwise configured.

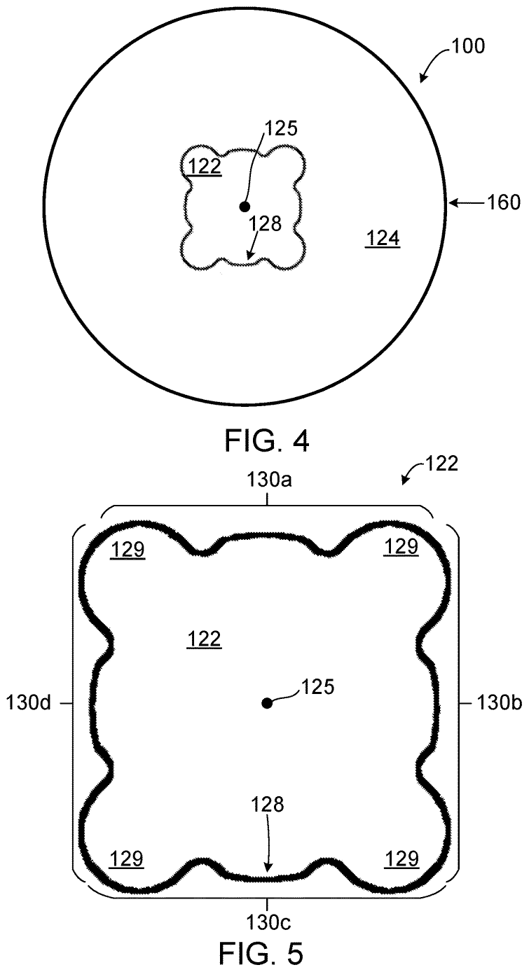

The rollers 100 may comprise flexible hubs to facilitate mounting and dismounting of the respective roller on the mounting shaft 12. Each roller may snap lock onto the shaft 12 in a corresponding mounting region 14 by rotating the roller 100 a selected degree, as described below. As shown in FIG. 4, each roller 100 has a substantially disc-shaped body with a radially outer rim 160 that extend axially from a first side face 124 to an obverse second side face across the roller's axial width, or thickness. A bore hole 122 for receiving the mounting shaft 12 extends along a longitudinal axis 125 from the first side face 124 to the second side face and is defined by an inner edge 128. The roller can have a solid body, or a body comprising spokes connecting the inner edge 128 of the bore hole 122 to the outer rim 160 or other suitable connectors.

As shown in FIG. 5, the inner edge 128 is formed by a series shaped sections 130a, 130b, 130c, 130d joined together end to end to bound a central bore 122. The inner edge 128 forms a shape that is rotationally symmetric about the longitudinal axis 125 by a factor of n, with n being the number of corners 16 in the associated mounting shaft 12, which is four in the illustrative embodiment. The shaped sections 130a, 130b, 130c, 130c cooperate to form four clearance regions 129 for the corners 14 of the shaft 12. Each clearance region is formed at the intersection of two successive shaped sections 130. The inner edge 128 also forms retaining features between the clearance regions 129 for retaining the shaft 12 when the shaft is in a selected orientation within the bore hole 122.

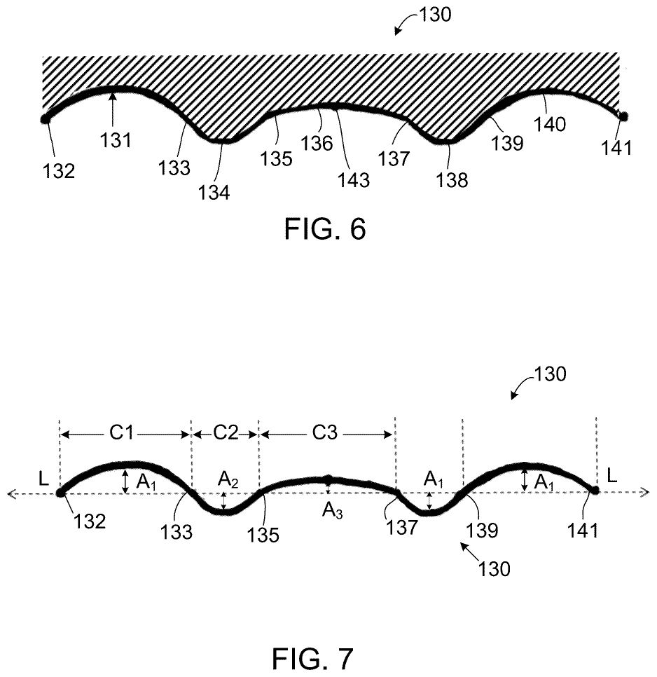

Referring to FIG. 6, each shaped section 130 of the inner edge 128 includes a retaining region between end clearance regions. In an illustrative embodiment, a shaped section 130 starts at a first point 132. A first concave curve 131 arcs from the first point 132 through about 90° to a second point 133 and forms half of a clearance region 129 in conjunction with a concave curve of an adjacent shaped section. At point 133, the shaped section 130 inflects into a convex curve 134 forming a first flexible retaining tab that protrudes inwards into the roller bore hole 122. The convex curve 134 has a radius of curvature that is smaller than the radius of curvature of the first concave curve 131. At inflection point 135, the shaped section 130 transitions to a shallow concave curve 136 forming a retaining recess. The shallow concave curve 136 has a radius of curvature that is larger than the radius of curvature of the first concave curve 131. The shallow concave curve 136 extends through a smaller central angle, which may be between about 30° and about 60° and preferably about 45°, then inflects at another inflection point 137 to another convex curve 138 forming a second flexible retaining tab. The second convex curve 138 is substantially identical to the first convex curve 134. The second convex curve 138 inflects at inflection point 139 to a third concave curve 140 that is identical to the first concave curve 131 and forms half of a second clearance region for a second corner 14 of a shaft. The end 141 of the third concave curve 140 coincides with the beginning 132 of a successive shaped section 130.

The illustrative shaped section 130 has mirror image symmetry about its midpoint, which coincides with the nadir 143 of shallow retaining curve 136.

As shown in FIG. 7, the inflection points, 133, 135, 137 and 139 and end points 132, 141 of a shaped section 130 align along a line L. The end concave curves 131, 140 have an amplitude A1 (the distance from line L to the top of the curve) that is larger than the amplitude A2 of the curves 134, 138. The amplitude A2 of the curves 134, 138 is larger than the amplitude A3 of the retaining recess 136 in the embodiment shown, but the inventio is not so limited and alternatively, the amplitude A3 of the retaining recess 136 may be larger.

The chord C1 between points 132 and 133 has a length that is slightly larger than the length of the chord C3 between points 135 and 137. The chord C2 extending between points 133 and 135 is smaller than the chords C1 and C3. In an embodiment, the chord C3 has a distance approximately equal to the distance between the edges 171, 172 of a shaft angled surface 17 in the mounting region 14.

The invention is not limited to the illustrative shaped section 130, and the inner edge 128 may have any suitable configuration forming clearance regions and retaining sections, as described below.

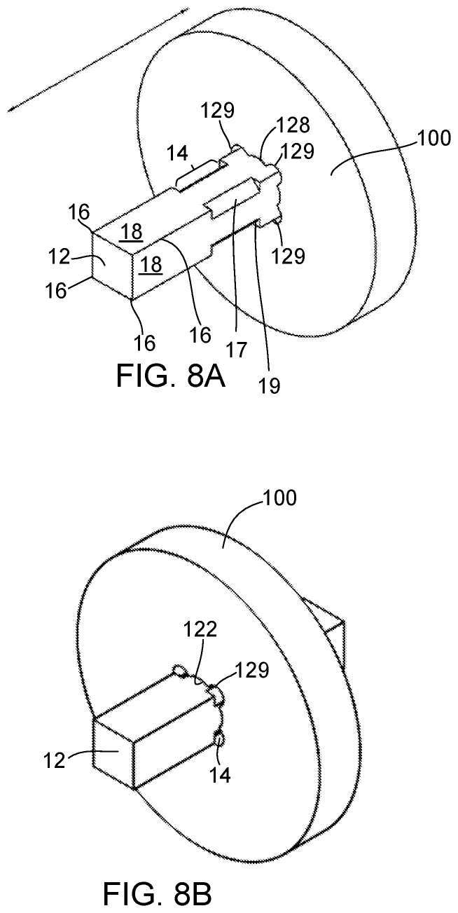

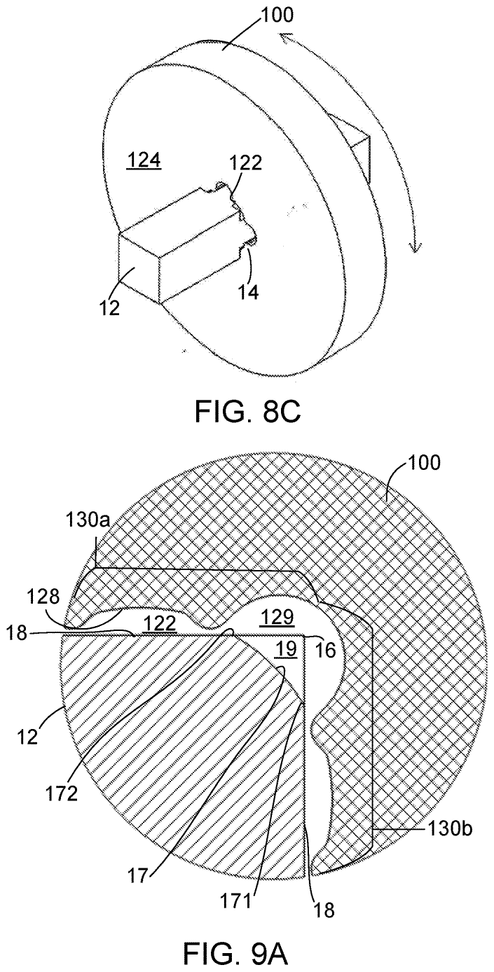

FIGS. 8A-8C illustrate a sequence of steps of mounting a roller 100 on a square shaft 12 according to an embodiment. First, as shown in FIG. 8A, the four corners 16 of the square shaft 12 are axially aligned with the clearance regions 129 formed by the large concave curves 131. In this position, the roller 100 can freely move along the length of the shaft 12. The roller 100 is then slid axially along the shaft 12 to its desired axial position so that a mounting region 14 is within the bore hole 122, as shown in FIG. 8B. Then, as shown in FIG. 8C, the roller 100 is rotated 45° in either direction to snap the roller 100 into a locked position on the shaft 12. The roller 100 is locked onto the shaft 12 by bringing the angled surfaces 17 in the mounting regions 14 into the retaining regions formed in the bore hole 122 to lock the roller 100 onto the shaft 12. The flexible bore hole 122 flexes slightly to accommodate the rotation of the shaft 12 before locking onto the shaft in the locked position.

In the locked position, the triangular containing walls 19 of the mounting region abut the side faces 124 of the roller 100 near the retaining regions of the bore hole inner edge 128 to help contain the roller axially along the shaft.

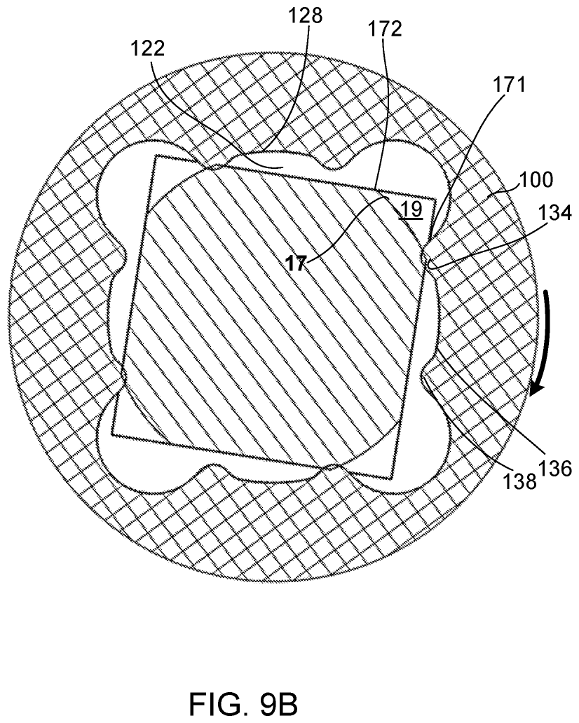

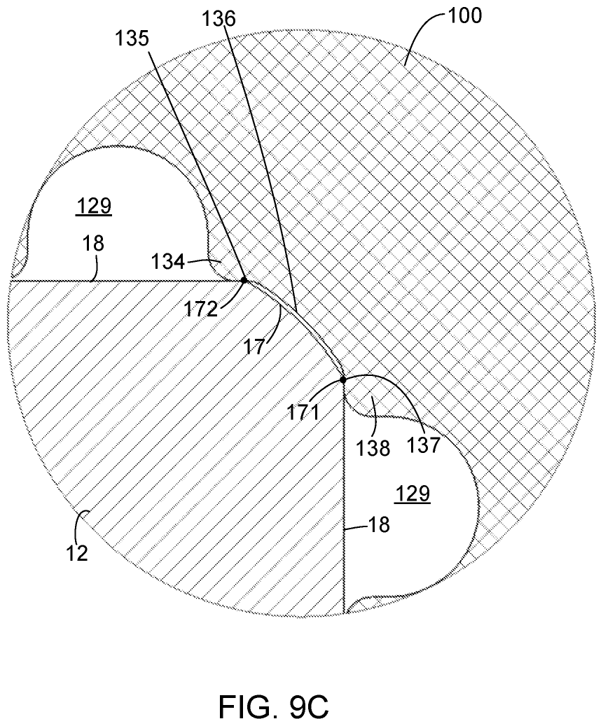

FIGS. 9A-9C are cross-sectional views of a portion of the shaft 12 and bore hole of a roller 100 during mounting of the roller 100 on the shaft 12. As shown in FIG. 9A, when the corners 16 are aligned with the clearance regions 129 formed by cooperating shaped sections 130a, 130b, the corners 16 and side walls 18 are clear of the shaped sections 130 defining the inner edge 128 the bore hole 122. Each angled surface 17 in the shaft mounting region extends from a first edge 171 at a first wall 18 to a second edge 172 at a second side wall 18.

Referring to FIG. 9B, as the roller 100 rotates relative to the shaft 12, the first edge 171 of each shaped corner 17 contacts a first flexible retaining tab formed by a first convex curve 134. As more torque is applied, the flexible retaining tab 134 flex away from the first edge 171 to slide the angled surface 17 into the retaining recess formed by the shallow concave curve 136, as shown in FIG. 9C. In the locked position shown in FIG. 9C, the flexible retaining tabs 134, 138 straddle the angled surface 17 to contain the shaft 12. The first edge 171 of the angled surface 17 abuts the inflection point 137 between the shallow concave curve 136 and second flexible tab 138 and the second edge 172 of the angled surface abuts inflection point 135 between the shallow concave curve and the first flexible tab 134 to retain the shaft 12.

The roller 100 can be unlocked and removed from the shaft 12 by rotating the roller 45° in either direction to snap the mounting regions 14 out of engagement with the flexible retaining tabs 134, 138, so that the corners 16 align with the clearance regions 129. Then, the roller 100 can slide axially along the shaft 12.

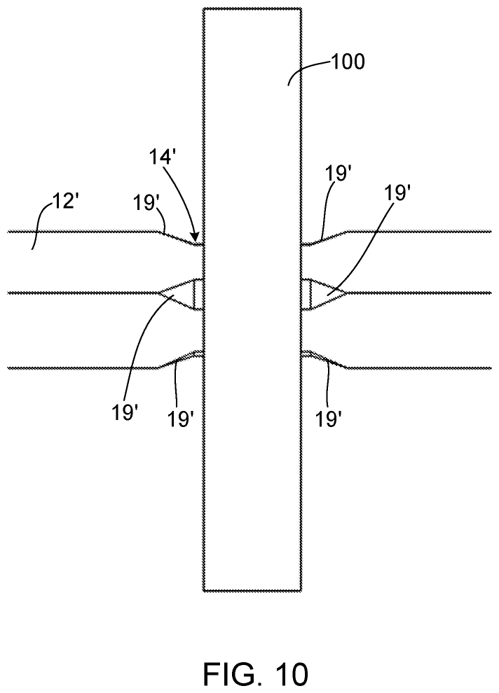

In one embodiment, shown in FIG. 10, the shaft 12′ can have containing walls 19′ forming axial ends of a mounting region 14′ that are sloped.

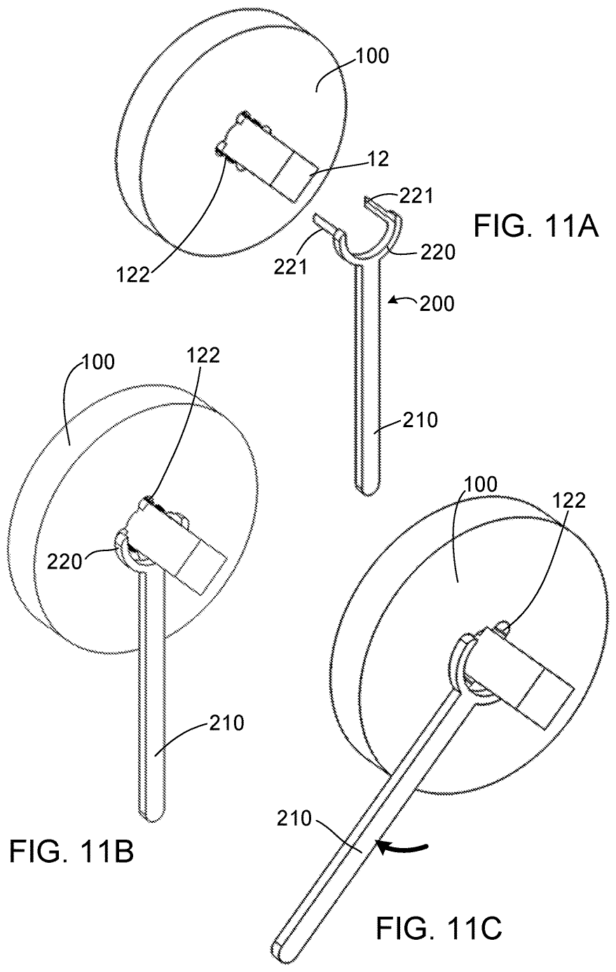

While the roller 100 or multiple rollers 100 can be mounted on an associated shaft 12 manually, in one embodiment, the rollers can be configured to engage mounting tools to facilitate assembly and—or disassembly of a roller assembly. For example, in one embodiment shown in FIGS. 11A-11C, a mounting tool 200 can be used to rotate the shaft 12 relative to the roller 100. The mounting tool comprises a handle 210 terminating in a c-shaped cradle 220 for holding the shaft 12. Fingers 221 extend from the tips of the cradle 220 and are configured to be inserted in clearance regions 129 between the shaft 12 and roller 100, as shown in FIG. 11B. When the mounting tool 200 rotates, it snaps the shaft 12 into the locked position within the bore hole 122.

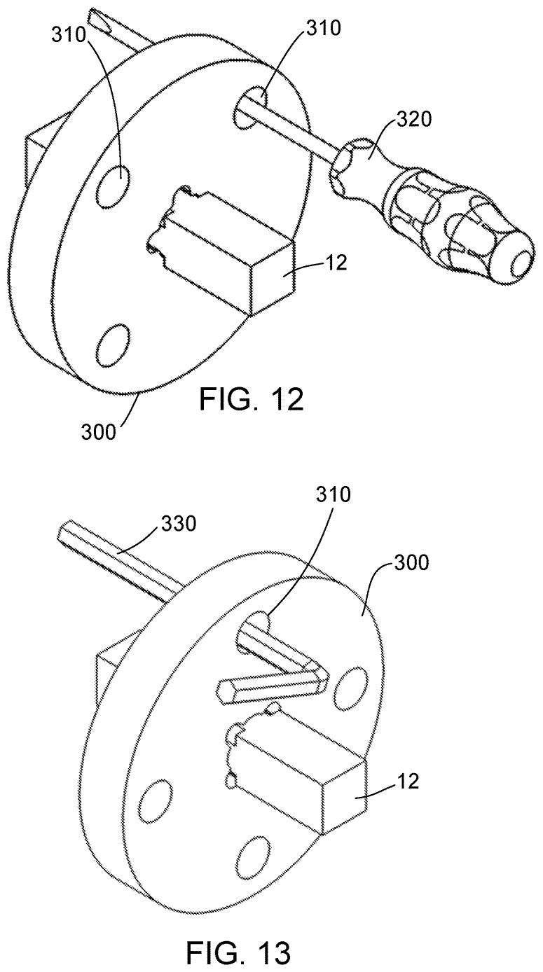

In another embodiment, shown in FIGS. 12 and 13, a roller 300 with a flexible bore hole can include holes 310 or other features that engage a tool, shown as a screwdriver 320 or an Allen wrench 330, to facilitate rotation of the roller 300 about the shaft 12 to selectively lock the roller 300 onto the shaft. Other suitable tools may also be used.

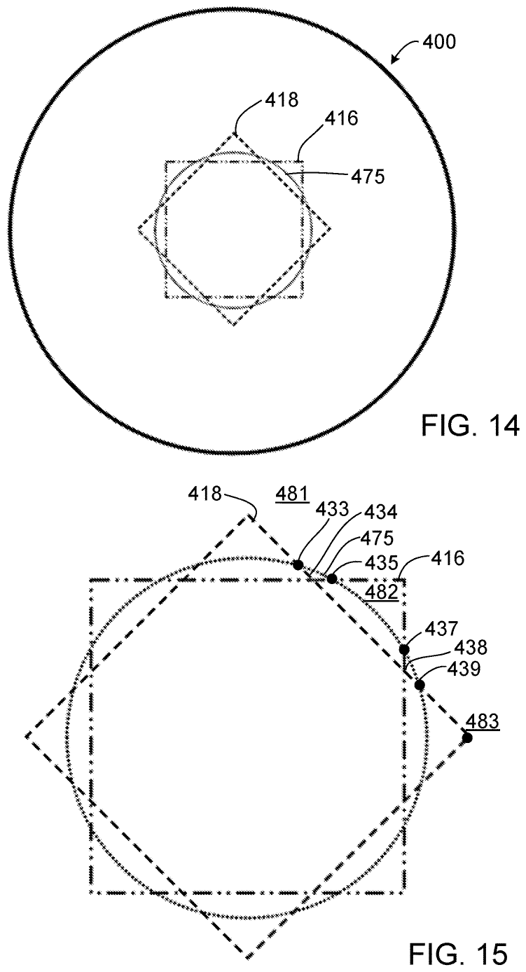

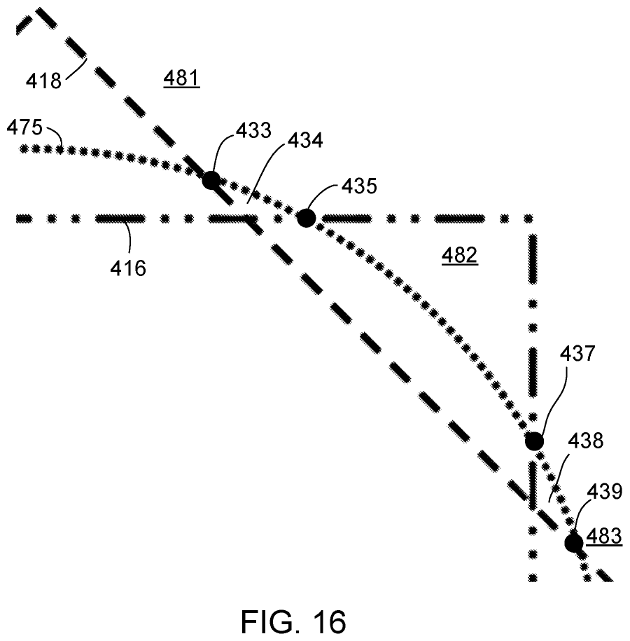

The invention is not limited to the illustrative bore hole for mounting and toollessly locking a roller onto a mounting shaft. For example, FIGS. 14-16 show the boundaries used to design the parameters of a flexible bore hole of a roller 400 or other conveyor component according to an embodiment. The flexible bore hole can be defined by a first shape, shown as a square 416, corresponding to the walls 16 of a shaft upon which the roller 400 is to be mounted. The flexible bore hole can also be defined by a circle 475 centered on the square 416 and defining the angled surfaces 17 of a cut in the shaft corners forming the mounting region. A diamond 418 corresponds to the square 416 rotated 45 degrees.

The first portion of a shaped section, forming half of a clearance region, extends outside of the boundaries defined by the square 416, diamond 418 and circle 475 and can be formed anywhere in region 481 terminating at point 433 (an intersection between the circle 475 and the diamond 418). The first flexible protrusion of the shaped section can be formed in region 434, which is outside both the diamond 418 and square 416 but within the circle 475. Point 435 (an intersection between the circle 475 and the square 416) defines the transition between the first flexible protrusion and a retaining recess for containing the angled surfaces 17 of the mounting shaft 12. The retaining recess can have any size, shape and configuration in region 482 outside of the circle 475 and between points 435 and 437 (a second intersection between the circle 475 and square 416). The second flexible protrusion is formed in region 438, which is a second region formed within the circle 475, but outside both the square 416 and diamond 418 between points 437 and 439. A final portion of the shaped section forming a portion of a second clearance region for a corner, extends from point 439 in a region 483 outside the square 416, diamond 418 and circle 475.

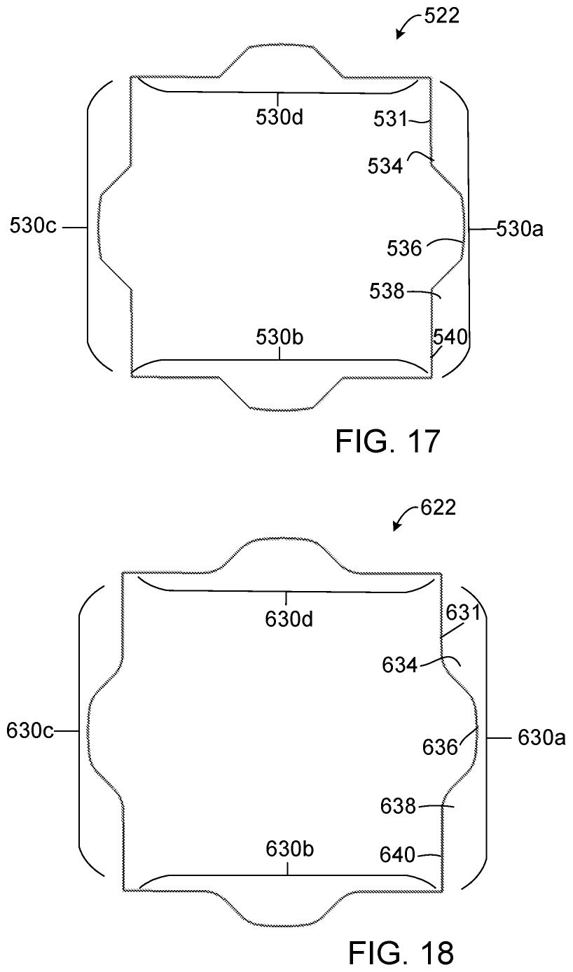

FIGS. 17-22 show examples of bore holes for a conveyor component, such as a roller, including a plurality of shaped sections forming clearance regions and retaining regions designed using the parameters described with respect to FIGS. 14-16.

FIG. 17 shows a bore hole 522 comprising shaped sections 530a, 530b, 530c, 530d. Each shaped section includes a first clearance section 531 extending outside a shaft wall, a first flexible protrusion 534, a retaining recess 536 for seating an angled wall 17 of a shaft, a second flexible protrusion 538 and a second clearance section 540 for a corner. The illustrative sections comprise straight segments.

FIG. 18 shows another embodiment of a bore hole 622 comprising shaped sections 630a, 630b, 630c, 630d. Each shaped section includes a first clearance section 631 extending outside a shaft wall, a first flexible protrusion 634, a retaining 636 for seating an angled wall 17 of a shaft, a second flexible protrusion 638 and a second clearance section 640 for a corner. The clearance sections are straight segments, but the flexible protrusions 634, 638 are formed by curves.

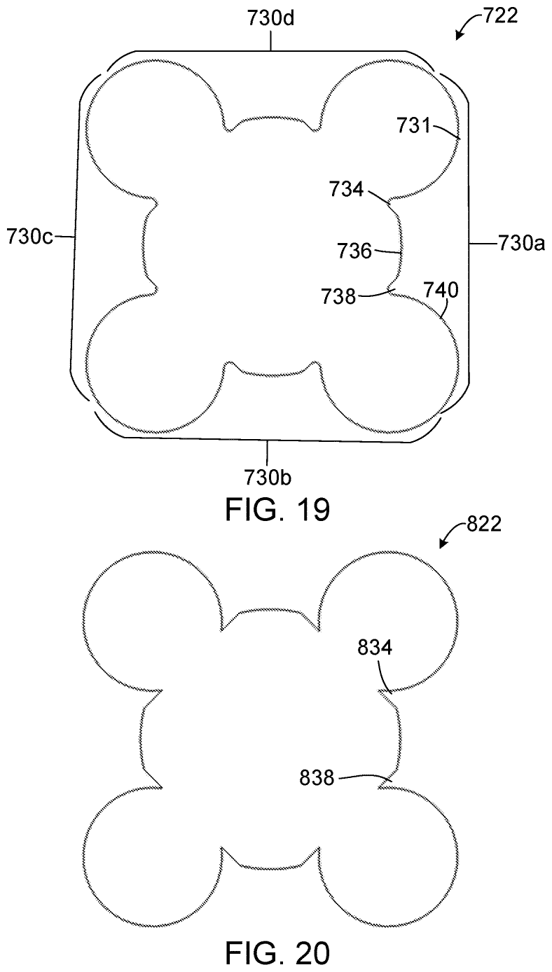

FIG. 19 shows another embodiment of a flexible bore hole 722 comprising shaped sections 730a, 730b, 730c, 730d. Each shaped section includes a first curved recess 731 defining a first clearance region for a shaft corner, a first flexible protrusion 734 having a curved tip, a retaining recess defined by a concave curve 736, a second flexible protrusion 738 having a curved tip and a second curved recess 740 for a corner.

FIG. 20 shows another embodiment of a flexible bore hole 822 similar to the bore hole 722, but with pointed flexible protrusions 834, 838.

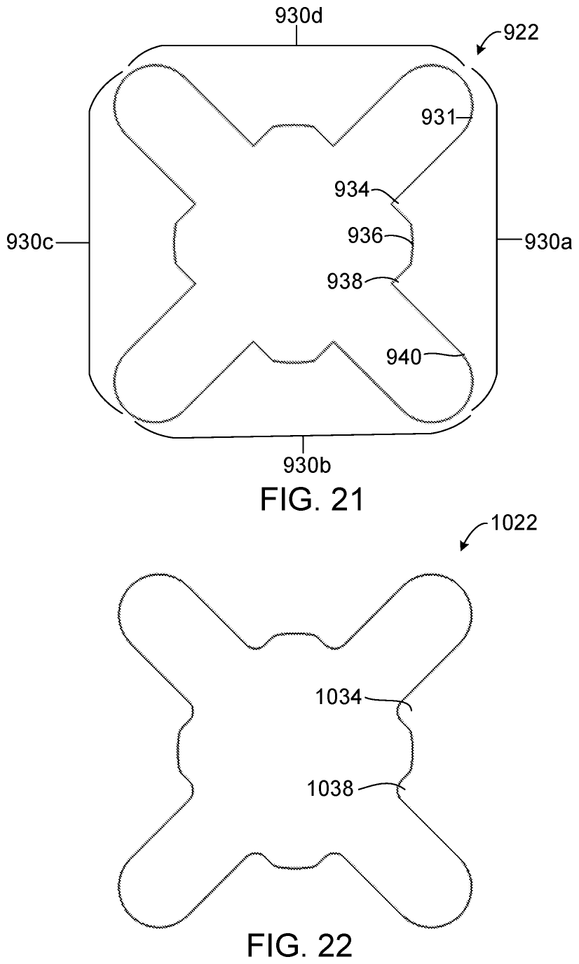

FIG. 21 shows another flexible bore hole 922 comprising shaped sections 930a, 930b, 930c, 930d forming clearance regions for shaft corners and retaining regions for retaining the roller or other conveyor component on a mounting region of a shaft. Each shaped section comprises a first clearance section 931 comprising an elongated slot formed by a curved wall transitioning to a straight wall, a first flexible protrusion 934 having a pointed tip, a retaining recess defined by concave curve 936, a second flexible protrusion 938 having a pointed tip, and a second clearance section 940 for a corner defined by a straight wall transitioning to a curved wall.

FIG. 22 shows another embodiment of a flexible bore hole 1022 similar to the bore hole 922 but with rounded flexible protrusions 1034, 1038.

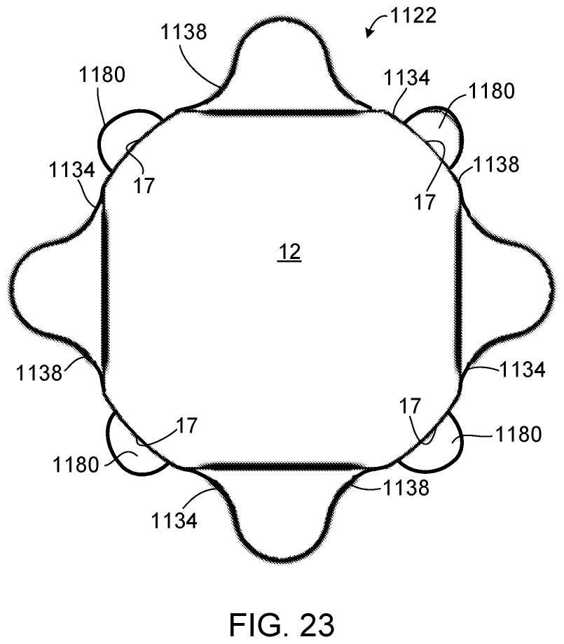

As shown in FIG. 23, a flexible bore hole 1122 in a conveyor component, such as a roller, may include relief openings 1180 between flexible protrusions 1134, 1138. The relief openings 1180 provide clearance between the angled walls 17 of the shaft 12 and walls of the flexible bore hole 1122.

While the illustrative embodiments show a roller, the illustrative flexible hub comprising successive shaped sections bounding a central opening and forming clearance regions for accommodating shaft corners in a first orientation and retaining features for locking onto the shaft in a second orientation can be used with any conveyor component designed to be mounted on a shaft, such as a shoe, sprocket, pulley, position limiter, side guard and other components known in the art.

Although the invention has been described in detail with regard to specific versions, other versions are possible. For example, all the rollers described in detail are designed for square shafts. But the basic design can be modified to accommodate other N-sided polygonal shafts, such as triangular, pentagonal, hexagonal, and so on. For other N-sided shafts, the inner edge is formed by a series of N shaped sections to match the number of sides on the polygonal shaft. Furthermore, the roller in the exemplary versions are described as locking onto a shaft. But the illustrative bore hole configuration can be used to mount other shaft mounted components, such as sprockets, pulleys, shoes and so on. So, as these few examples suggest, the scope of the claims is not meant to be limited to the details of the exemplary versions used to describe the features of the invention.

What is claimed is:

1. A combination of a shaft and a roller mounted on the shaft for a conveyor system, comprising:
a shaft extending along a longitudinal axis and having n flat surfaces intersecting at n corners and a plurality of mounting regions, each mounting region comprising an angled surface in each corner of the shaft; and
a roller mounted on the shaft, the roller comprising a body having a flexible bore hole, the bore hole defined by n shaped sections, each shaped section comprising a first portion forming a clearance region for a corresponding corner, the first portion transitioning to a first flexible tab for containing the shaft by contacting a first edge of an angled surface, the first flexible tab transitioning to a retaining recess, the retaining recess transitioning to a second flexible tab for contacting a second edge of the angled surface.

2. The combination of a shaft and a roller of claim 1, wherein the second flexible tab transitions to a clearance portion that matches the first portion.

3. The combination of a shaft and a roller of claim 1, wherein the shaped section has mirror-image symmetry about the nadir of retaining recess.

4. The combination of a shaft and a roller of claim 1, wherein the angled surfaces are convexly curved.

5. The combination of a shaft and a roller of claim 4, wherein n equals 4, the shaft has a square cross section and the angled surfaces form arcs of a circle having a diameter D that is greater than a height and width of the shaft but less than a diagonal G of the shaft.

6. The combination of a shaft and a roller of claim 1, further comprising a mounting tool for rotating the shaft relative to the roller to lock the roller onto the shaft.

7. The combination of a shaft and a roller of claim 1, wherein the first flexible tab is rounded.

8. The combination of a shaft and a roller of claim 1, wherein the retaining recess comprises a concave curve.

9. The combination of a shaft and a roller of claim 1, wherein the clearance region comprises an elongated slot.

10. The combination of a shaft and a roller of claim 1, wherein the clearance region comprises a first concave curve that extends through a 90° arc and a second concave curve that extends through a 90° arc and terminates at an end point of the first concave curve.

11. The combination of a shaft and a roller of claim 1, wherein the shaped section includes inflection points and end points that align along a line L.

12. A conveyor component, comprising:
a body; and
a flexible bore hole for mounting the body to a shaft, the flexible bore hole defined by n shaped sections, each shaped section comprising a first clearance portion, the first clearance portion transitioning to a first flexible tab, the first flexible tab transitioning to a retaining recess, the retaining recess transitioning to a second flexible tab and a second clearance portion identical to the first clearance portion extending from the second flexible tab and terminating at the beginning of a successive shaped section.

13. The conveyor component of claim 12, wherein the first flexible tab and second flexible tab are rounded.

14. The conveyor component of claim 12, wherein the retaining recess comprises a concave curve.

15. The conveyor component of claim 12, wherein the shaped section includes inflection points and end points that align along a line L.

16. The conveyor component of claim 12, wherein n equals 4.

17. A method of mounting a roller on a shaft in a conveyor system, comprising the steps of:
aligning corners on the shaft with clearance regions in a bore hole on the roller;
sliding the roller along the shaft until a mounting region of the shaft is within the bore hole; and
rotating the roller about the shaft so that angled surfaces in the mounting region on the shaft snap into retaining features in the bore hole.

18. The method of claim 17, wherein the step of rotating comprises using a mounting tool to rotate the roller relative to the shaft.

19. The method of claim 17, wherein the mounting region of the shaft comprises comprising an angled surface in each corner of the shaft and the retaining features comprise flexible tabs separated by a retaining recess for engaging the angled surface.
